(19) United States
(12) Patent Application Publication
(10) Pub. No.: US 2005/0144463 A1
(43) Pub. Date: Jun. 30, 2005

(54) Single sign-on secure service access

(75) Inventors: Judith Rossebo, Oslo (NO); Jon Olnes, Oslo (NO)

Correspondence Address: BIRCH STEWART KOLASCH & BIRCH, PO BOX 747, FALLS CHURCH, VA, 22040-0747, US

(73) Assignee: Telenor ASA, Fornebu (NO)

(21) Appl. No.: 10/507,131

(22) PCT Filed: Mar. 18, 2003
(86) PCT No.: PCT/NO03/00093

(30) Foreign Application Priority Data
Mar. 18, 2002 (NO) 20021341

(51) Int. Cl. H04K 1/00

(52) U.S. Cl. 713/185; 709/247; 713/182

(57) ABSTRACT

This invention relates in general to authentication, authorisation, and access control, and more specifically to a method and a system for general Public Key Infrastructure based authentication allowing users to have only one electronic ID for secure access to all services. The system described advances the state of the art by providing general, PKI-based authentication. By offering validation and possibly also authorisation services to other service providers, the system can provide an infrastructure for general, PKI-based authentication, handling electronic IDs from in principle any issuer of such.

This invention relates in general to authentication, authorisation, and access control, and more specifically to a method and a system for general PKI (Public Key Infrastructure) based authentication allowing users to have only one electronic ID for secure access to all services.

### BACKGROUND

Authentication, authorisation, and access control are three areas that are essential for most (communication) service providers. The only exceptions are entirely open services and anonymous pay-per-use services. This specification covers the normal situation, where named users are authorised for use of specific services. Upon successful authentication, a user is given access to these services, subject to access control procedures.

Today's authentication solutions towards ISPs (Internet Service Provider) or other providers of IP-based (Internet Protocol) communication infrastructure are mainly based on usernames and passwords. The RADIUS (Remote Authentication Dial-In Service) protocol (and other protocols like TACACS+ (Terminal Access Controller Access Control System)) provides access to services that provide centralised administration and validation of both the authentication information and of the authorisations that are assigned to the (authenticated) username. Work in IETF (Internet Engineering Task Force) is ongoing for the next generation of such protocols through the Diameter working group.

Usually, the user is required to have a separate password per service. Password-based authentication becomes complicated as more and more services are provided, especially as each service usually requires a separate password authentication. To manage this complexity, users typically choose passwords that are easy to remember, and use the same (username and) password over and over.

As more and more value-added services are offered over the Internet, it is important to provide users with open PKI-based (Public Key Infratructure) user authentication to replace the complexity and weaknesses of password-based authentication, protect the user against theft of services, and simplify login procedures (one electronic ID for access to all services). Strong authentication will also be required to protect customers and service providers against fraud.

The state-of-the-art in the PKI area is not yet at this level of generality. Instead, users are now often faced with use of different PKI-solutions (instead of different usernames and password) for access to different services. Also, not too many services are at present “PKI-enabled”, although this functionality may be latent to many services in the form of SSL/TLS (Secure Socket Layer/Transport Layer Security) client authentication procedures. The system described advances the state of the art by providing general, PKI-based authentication. By offering validation and possibly also authorisation services to other service providers, the system can provide an infrastructure for general, PKI-based authentication.

This specification describes an improved solution for authentication, authorisation and access control by use of certificates and PKI technology, as well as enabling mechanisms for payment services provided over computer networks. The main virtues of a PKI solution are generality, scalability, and increased functionality (key management for encryption, digital signature). In the future, a user should have one key container (e.g. a smart card) containing the private keys and certificates that forms the user's electronic ID. An electronic ID usually consists of two or three different private key/certificate pairs for different purposes. Most solutions use two pairs, one for encryption (allowing backup of this particular private key only) and another one for all other purposes. It is frequently recommended to attribute the digital signature function to a separate, third pair, but this has not achieved widespread support in products or services.

The user should be free to select issuer of the electronic ID (certificate service provider). The services that the user wants to access should not mandate use of particular certificate issuers. A user must be free to obtain as many electronic IDs as desired.

Today, service providers that use PKI-based authentication of the users typically can accept certificates from only one or a few certificate issuers. Since certificate services are different, service providers must to some extent integrate separately towards all issuers. This quickly becomes too complex to be useful, when certificates from more than a few issuers shall be accepted.

At the same time, there are at least several hundred public certificate service providers in the world, with more to come. A service provider may also want to accept certificates from miscellaneous company internal certificate services (that are normal for intranet use).

The architecture described separates the complexity of integration towards a multitude of certificate issuers to dedicated components, thus removing this complexity from the services themselves. A user must register the electronic ID(s) (i.e. the certificate(s)) that the user wants to use. The name in the certificate, and other characteristics like its quality level, are linked to the user's service profile.

The service profile is maintained in a single place. Certain services may demand a high-quality electronic ID to allow access.

The name in the certificate need not be the user's real name. Subject to policy, this may be a pseudonym, a role name, an organisational identity, a subscription name, and so on.

Using the electronic ID, a user can subsequently log on to the network and obtain access to all the services that the user subscribes to. The system described can provide single sign-on towards services that are prepared for this. Towards services that require their own authentication, the virtue of the system is that the user's electronic ID can be re-used, instead of having to maintain a different password for each service. The user must authenticate several times but uses the same method all the time. This relies on the availability of the described validation service, and to some extent also the authorisation service.

The flexibility of this system also allows users to choose the operating system freely. Software for electronic ID solutions is frequently platform dependent. With an open PKI solution, the user can chose an electronic ID, which can be supported by the operating system of choice.

Credit card companies are beginning to require user authentication for payments over the Internet, and password authentication will only be acceptable in the short run. Establishing a general PKI will allow the credit card company to accept the electronic ID already owned by the user (provided it qualifies) instead of having to issue a separate electronic ID for use in making payments.

The system described will provide a means to secure authentication, authorisation, and access control for value-added services such as Video on Demand (VOD) as well as providing a means for securing payments.

### SUMMARY OF THE INVENTION

This invention relates in general to authentication, authorisation, and access control, and more specifically to a method and a system for general Public Key Infrastructure based authentication allowing users to have only one electronic ID for secure access to all services. The system described advances the state of the art by providing general, PKI-based authentication. By offering validation and possibly also authorisation services to other service providers, the system can provide an infrastructure for general, PKI-based authentication.

The invention relates to a system as set forth in the appended, independent claim 1. Further, the invention relates to a use as set forth in the appended, independent claim 11. The invention also relates to a method as set forth in the appended, independent claim 13. Advantageous embodiments of the invention are set forth in the dependent claims.

### DESCRIPTION WITH REFERENCE TO THE DRAWINGS

The invention shall now be described with reference to the accompanying drawings in which:

FIG. 1 shows the authentication and authorisation architecture overview;

FIG. 2 shows an alternative method for checking the validity of a user certificate;

FIG. 3 shows a flow chart of authentication, authorisation checking, and service access process;

FIG. 4 shows access to value-added service, and

FIG. 5 shows the validation service overview.

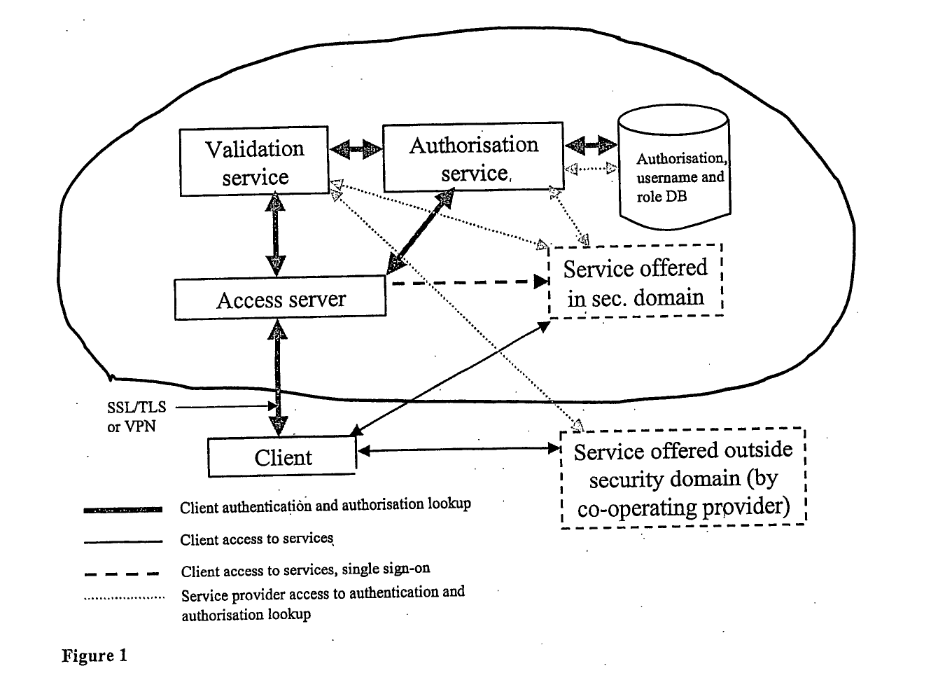

FIG. 1 shows the system architecture according to the invention. The user is authenticated, typically by SSL/TLS client authentication, and given access, on the access server, to a web interface with a menu for the subscribed set of services. Communication between the client and the access server must be cryptographically protected. SSL/TLS is the preferred option, since this is the usual way of protecting web (HTTP) communication, and can incorporate user authentication. A solution based on IPSecNPN (Internet Protocol Security/Virtual Private Network) between the two parts may be an alternative.

The authentication protocol applied (like SSL/TLS with both client and server authentication) implicitly identifies the user by the name in the user's certificate, which is passed to the access server as a part of the protocol. The user must also use the corresponding private key to sign a challenge/response sequence that proves possession of the private key.

Given the user's certificate and signature, the access server may complete the user authentication process. However, when done properly with revocation checking and in a manner that allows for different certificates from different certificate issuers, certificate validation is a far too heavy process to run on each access server. In the architecture, a separate component, the validation service, is introduced to take the responsibility (and load) for (parts of) the certificate processing. The validation service may be replicated if necessary. Ultimately, the access server may merely extract the user's certificate and ship it off to the validation service. The return is a yes/no answer on the certificate's validity, its quality level (that may be relevant with respect to the authorisations that can be granted), the username, which is derived from the name in the user's certificate, and possibly more information if desired. However, one may also separate the load between the access server and the validation service differently, e.g. by performing most certificate processing locally on the access server, and leaving mainly the (normally resource consuming) task of revocation checking to the validation service.

The users' profiles should be kept in one place, namely the authorisation service. The mapping from a user's certificate name to the corresponding username is a part of the profile, and consequently the validation service calls the authorisation service in order to obtain this mapping after extracting the name from the certificate. Alternatively, the validation service may return the certificate name to the access server, which can then perform the name mapping by a separate call to the authorisation service. In this case, there is no interface between the validation service and the authorisation service.

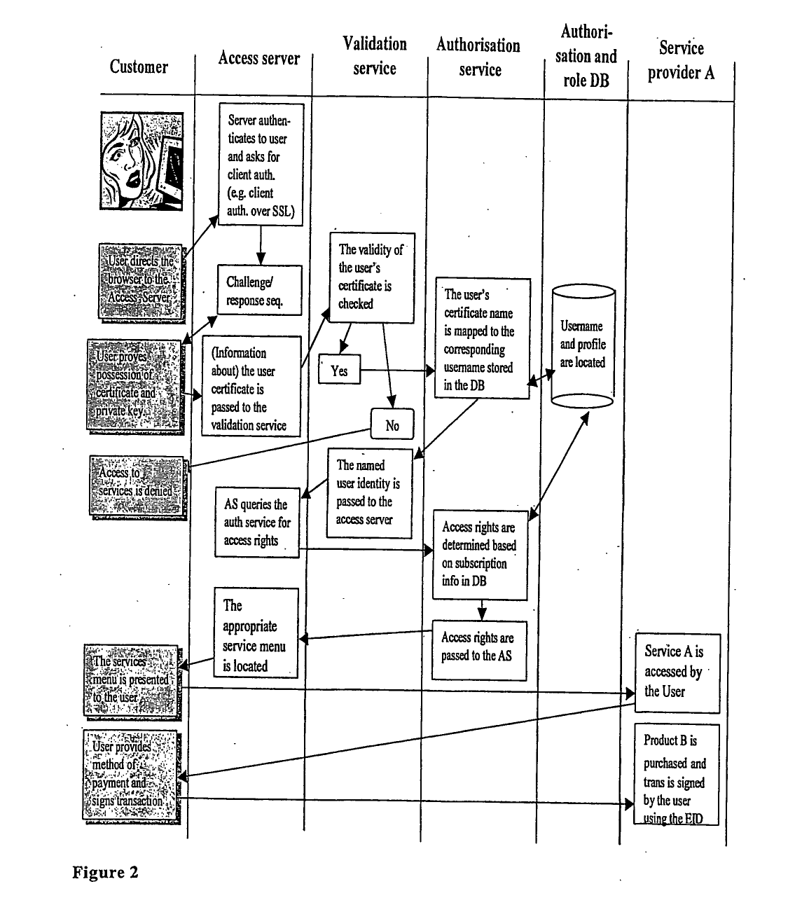

FIG. 2 shows a flow chart of the authentication, authorisation checking, and service access process. Several protocols may be used towards the validation service. If the validation service shall be offered to service providers as a separate service, then the protocol must be of a standard type. OCSPv1 (On-line Certificate Status Protocol, version 1) is an alternative that makes it possible to check revocation status of a certificate and return some additional information, like a usemame. However, it is not possible to pass on a complete certificate to the validation service in a standardised way, only by use of a non-specified “extension”. OCSPv2 is in an advanced draft RFC, and will provide the possibility of sending a complete certificate. SCVP (Simple Certificate Validation Protocol) has the same status as OCSPv2, and provides the same functionality. XKMS (XML Key Management Service) is another alternative, as is other XML-based mechanisms, e.g. using SOAP (Simple Object Access Protocol).

Given the authenticated user identity, the access server then queries the authorisation service about the access rights that the named user should be granted. The query may be augmented by additional information like the quality of the user's authentication procedure, and context information like the user's current location, time of day etc. Access to the authorisation service should be based on a standard protocol, which may be LDAP (Lightweight Directory Access Protocol), RADIUS, its planned successor DIAMETER, or some other protocol.

It is also possible to delegate the lookup towards the authorisation service to the validation service. In this case, the access server will perform only the call to the validation service, and get back both the username and other information related to the authentication procedure as described above, and the authorisations that the user shall be granted.

Following this procedure, the user will be presented with the correct service menu. Service selection is the next step, as described below.

The flow chart in FIG. 2 shows the steps taken in the authentication, authorisation checking, and service access procedures.

In the following, a typical connection set-up and access to services will be described. The user's equipment or home network is connected to the infrastructure offered by the network operator via some kind of access point, which typically provides protocols at the data link or access layer, and the network layer, i.e. the IP-protocol. The access point is not shown in FIG. 1, as it acts only as a router with respect to web access from the user to the access server. The access point may be separated into two components: one offering services at the data-link/access layer, and the other one being an IP-router.

When user equipment connects to the network infrastructure, it is typically provided with access to a default, minimum set of allowed communication paths. In the architecture shown, the route towards the access server must be enabled, and usually a Domain Name Service (DNS) will also be enabled. Further services/paths, may be added to this minimal configuration.

When the user opens a browser on the user's equipment, this must be directed at a URL at the access server in order for the user to gain access to services. The user must then go through the authentication procedure and authorisation checks, and will be given access to the service menu.

There are basically three types of services available: Communication services, Web-based services, and Media services, including multimedia. The third category can be described as a combination of the other two. The actions taken for each of these categories are described in the following.

Communication Services: When the user selects a communication service, this request needs to be mediated to the user's access point, in order to enable a route towards the destination selected. The route may be enabled at the IP-layer, opening up for traffic from the user's (range of) IP-address(es) to a certain (range of) destination(s). The route may also be enabled at the data-link layer, e.g. by establishment of an ATM (Asynchronous Transfer Mode) virtual circuit.

One example of a communication service may be general Internet access through an ISP. Selecting Internet access in the service menu will enable a route from the user to the ISP's access node (border router), from which access can continue.

The access server needs to mediate the correct commands to the user's access point in order to enable the requested communication service. Several protocols may be used for this purpose, with RADIUS as the most common alternative. DIAMETER is the planned successor to RADIUS.

There are three different scenarios for user access to web-based services from the service menu on the access server.

In a first scenario, the access server mediates direct access to the service in a single sign-on manner, by passing a single sign-on token to the service. In the simplest form, this is a username and a password for the service in a HTTP Post operation, thus logging the user transparently on to the service. The user is then either redirected to the service, or the access server continues operation as a HTTP-proxy intermediary. There are several products and technologies for single sign-on available, and tokens from such technologies may be used. Possibly, the access server may also write a cookie to the user's browser, which will be recognised and accepted as a single sign-on token when the user directly accesses the service. The service may have access to the authorisation service, e.g. to check more detailed privileges related to service use.

In a second scenario, the service is offered within the domain of the system described, but requires a separate authentication. The user's electronic ID (private key and certificate) is used towards the service, i.e. the user has a single mechanism. The service has access to the validation service, and may also use the authorisation service.

In a third scenario, the service is offered outside the domain of the system described. If the service is enabled for such authentication, then the user's electronic ID (private key and certificate) is used, i.e. the user has a single mechanism. The service has access to the validation service, but since it is not in the system's domain, it will not usually have access to the authorisation service.

The validation service is a general one, which may be offered to co-operating parties both inside and outside of the system's domain. The validation service may be configured to return different information (e.g. different usernames) dependent on the service that calls it. This is a direct result of the general nature of PKI-based authentication. One cannot allow this kind of access for password-based authentication, since passwords would be revealed to external parties.

The authorisation service however should normally only be accessible within the domain of the system. Allowing external parties access to domain-internal authorisation information, or even managing authorisation information through the same service, will in most cases not be acceptable.

Media/Multimedia Services: As stated, (multi-)media services may be regarded as a combination of communication services and web-based services. Some media services may be implemented entirely as web-based or communication but the usual scenario is a service that provides a web-based interface for service set-up, and a service realisation that relies on functionality in the network. If the access server acts as a proxy between the user and the media service, it may intercept communication and perform support actions like initiating a VPN between them, or providing information to a multicast membership system.

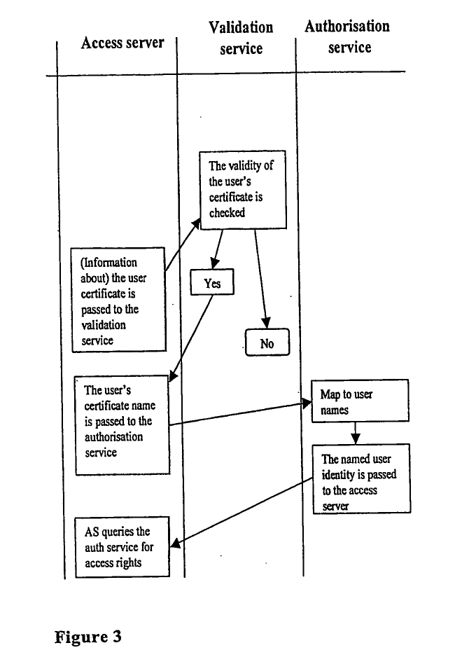

FIG. 3 shows an alternative way of checking the validity of a user certificate. Instead of sending the user's certificate name to an authorization service, it is sent to the access server, which in turn receives the named user identity from the authorization service.

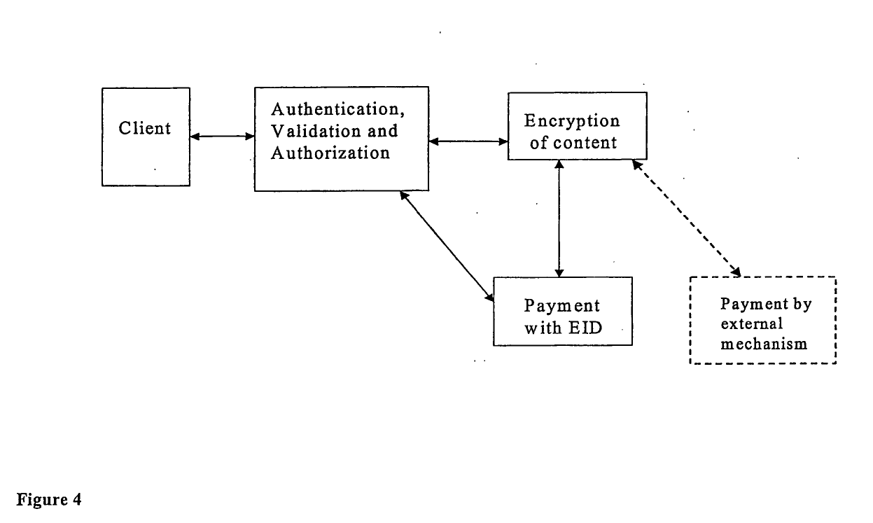

FIG. 4 shows an example of authentication, authorisation, and access to a value-added service such as Video on Demand (VOD) as well as secure payment (on a pay-per-use basis).

The user is authenticated using the authentication architecture described in FIG. 1. The content is protected by encryption during the entire duration of the session, and payment is ensured on a pay-per-use basis. The content can be encrypted using the users keys provided by the electronic ID. The user can choose the method of payment e.g. invoice or credit card, and sign the transaction using the electronic ID used for authentication. Alternatively, the user can select an external mechanism to be used for payment and for securing the transaction.

The invention will now be described in more detail with reference to FIG. 2. The access server acts as the users'access point to services by authenticating users, and providing them with the appropriate service menu. In order to perform its role in the system, the access server must:
Support HTTPS (HTTP over SSL/TLS) or alternatively be able to provide other means of secure communication channels;
Be able to authenticate itself to clients/users, preferably by use of PKI technology (e.g. SSL/TLS server authentication);
Support the protocols needed to communicate with the validation service and the authorisation service;
Support one or more protocols for PKI-based client/user authentication, usually SSL/TLS with client authentication
Implement the functionality needed to display the necessary information (such as the service menu) to the user, and to handle user input;
Be able to act as a proxy between a user and a service, i.e. mediate information transparently between them.

The user must direct the browser to the web-interface provided by the access server in order to access services. Normally, the user will be authenticated immediately through SSL/TLS with client authentication, as described above.

There are two alternative methods: If another PKI-based authentication method is used, a SSL/TLS session may be established with server authentication only, and the user authentication protocol may then be run on this secure channel. If several alternatives exist for authentication method, then the user may be faced with a clear text (i.e. pure HTTP) page for selection of method. Following selection, the authentication continues, e.g. by establishment of a SSL/TLS session with client authentication.

As described, the access server relies on obtaining the user's certificate from the user. Other means for obtaining a certificate, e.g. a directory loolcup, may be additionally implemented.

As described in the section below, regarding the validation service, as much as possible of local certificate processing should be disabled in the access server, and left to the validation service instead. The access server must validate the user's certificate by means of the validation service, verify the user's signature on the challenge part of the authentication protocol, and act according to the success or failure of this authentication. Creation of the challenge, and verification of the signature on the challenge, may be done externally to the access server. Since the access server is exposed to attacks from users, one may want to use a more protected computer for these security critical operations.

The first action following user authentication will normally be to fetch the user's service list from the authorisation service, unless this has already been obtained from the validation service. Later, the access server acts according to user input, in accordance with the policies in force, and in co-operation with the authorisation service for actions that require checks against user profiles. As described in FIG. 1, single sign-on mechanisms may be implemented.

The validation service is optimised for certificate processing. It receives a certificate, or identification of a certificate and its issuer, and:
Reads the name of the issuer.
Fetches the issuer's public key from a pre-evaluated list of “good” keys. All cross-certification regimes or hierarchies have been pre-processed, and all issuer public keys are directly trusted, i.e. no processing of certificate chains is necessary.
Performs revocation checking, preferably by a local call to pre-processed revocation information obtained by regular pre-fetching of CRLs (certificate revocation list).
If the complete certificate has been received, parses the certificate, checking signature and validity period and deriving the content. This needs to be handled individually for different certificate profiles.
Derives information mapped from the certificate information, like username derived from name in certificate, quality level (pre-determined based on an analysis of the certificate policy in question), and so on. Information may be general, or specifically targeted at the entity that called for the certificate validation.

These operations can be optimised in the validation service, providing the quick response times that are necessary. In particular, processing of certificate chains and revocation checking normally impose a heavy load on a server. For this reason, proper revocation checking is frequently suppressed in today's PKI-enabled services. The validation server relies on pre-processing of revocation information in order to speed up the process.

Several protocols may be used towards the validation service. OCSP (On-line Certificate Status Protocol) version 1 is available today but has no standard way of transferring a complete certificate. OCSP version 2, which is under development as an Internet draft, adds this possibility. Alternative protocols that may supplement or replace OCSP, are SCVP (Simple Certification Validation Protocol), which is an Internet draft protocol, and XKMS (XML Key Management System). Protocols may also be based on SOAP (Simple Object Access Protocol, in essence XML over HTTP) or similar technologies, or some proprietary protocol may be designed. All these protocols provide the possibility of returning additional information to the caller, along with the yes/no/unknown answer to the validation request itself.

OCSP is primarily targeted at as a replacement for CRL-issuing from one certificate authority. Instead of, or in addition to, CRLs, the certificate issuer provides an OCSP-interface that answers requests about the validity of certificates issued by this certificate authority only. In our context, the validation service will provide one OCSP-service for all certificate authorities that are supported.

OCSPv1 describes revocation checking as the only functionality of an OCSP-service. This is too narrow, and it is suggested to enhance this. Firstly, the validation service should not only check if the certificate has been revoked or not, but also if it is within its validity period, and that the issuer's signature on the certificate is correct. Furthermore, the validation service should also parse the certificate and act upon the contents by determining the quality level and the username, possibly also more information.

OCSP provides client authentication and integrity protection of requests by the possibility of letting the caller digitally sign (parts of) the request. Correspondingly the validation server may sign responses. This can also be implemented for other protocol alternatives. Signed responses may be very important, as faked or manipulated responses may constitute a significant threat. Signed requests may be necessary in order to return caller-specific information, unless the caller is otherwise authenticated.

However, since signature processing (that usually also implies certificate processing) is rather time-consuming, it may be better to ensure that calls to the validation service are made over a secure channel, e.g. by means of a VPN-solution. This should definitely be the case for the channel between the access server and the validation server, possibly also from other domain-internal services towards the validation service. If the validation service is provided towards external parties, provision for signed requests and replies must be implemented, as one probably cannot require VPNs or similar for all such external parties.

The following covers the requirements on servers that use the validation service. In particular, this is the access server.

Notably, such a service resides at the access server. In order to use the validation service, (parts of) the certificate processing should be “short-circuited” at these services. Some scenarios for processing in a server are described in the following:
SSL client authentication: The SSL processing at the server must extract the client's certificate, and either forward this to the validation service without further processing, or perform some processing locally before forwarding the complete certificate or information derived from it. Based on the reply, SSL set-up either continues or aborts.
Receipt of a digitally signed message: The client's (sender) certificate may be extracted from the message (or obtained by other means) and sent to the validation service. Alternatively, some certificate processing may be performed locally before the certificate, or information derived from it, is sent to the validation service. Following a successful validation, the signature on the message itself can be verified locally. The validation service may also be enhanced to handle all signature processing in the system, on messages as well as certificates.
Validation of a certificate that will- subsequently be used for (key management for) encryption of a message or a channel towards a given counterpart:
Processing will be analogous to the receipt of a certificate in a digitally signed message.
Establishment of a VPN: Processing will be approximately equal to the SSL client authentication scenario.
Other PKI-based authentication protocols: The server must obtain the client's certificate, and then call the validation service as indicated in the scenarios above. Certificate processing may either be left entirely to the validation service, or some local processing may be done.

To implement the call (protocol alternatives listed above) to the validation service, modifications to the server software are necessary. The amount of local processing that can be “short-circuited” depends on the modifications that are possible for the particular server platform. For optimal performance, the call to the validation service should be interleaved with other processing in the server, and partly or entirely replace functionality (local certificate processing) that is already in place in most server platforms. Such modifications are usually rather complicated, and depend on the openness of the platform. The alternative is addition of extra functionality on top of available, open interfaces, with local certificate processing only short-circuited to the extent possible by configuration parameters.

It is also possible to provide an interface for users (clients) towards the validation service. In this case, certificate processing in the user's browser (typically, may also be other software in the user's equipment) is entirely or partly replaced by a call to the validation service instead of local certificate processing. This is analogous to the server case. The primary use of such an interface will be processing of SSL server certificates, but there is also use related to VPN set-up, receipt of digitally signed messages, and validation of certificates that will be used for encryption of messages/traffic towards counterparts. In this case, replies from the validation service may be signed, and requests from users may be signed. If the validation service verifies signatures on certificates on behalf of the user, then the list of (today about 150) certificate issuer public keys, which are pre-configured in standard browsers (and for example in newer Microsoft OS versions), may be removed from the user's equipment. Management of (trust in) such issuer public keys by users is a major obstacle to PKI usage.

With regard to support for different certificate issuers, there are two basic ideas behind the introduction of the validation service:
Efficiency, by optimising this service for certificate processing, especially by getting rid of processing of certificate chains and by checking revocation by a local database lookup instead of CRL processing.
Provide a single point of integration for services that want to accept certificates from more than one certificate issuer.

Today, a service that uses PKI-based authentication must integrate individually towards each certificate issuer it wants to accept certificates from. The integration complexity in particular has to do with different certificate formats, different naming schemes, different access points for revocation information, and management of issuer public keys. A service can thus only integrate with a few selected certificate issuers directly. The validation service removes this complexity from the services.

However, even the validation service faces a complexity problem when many certificate issuers are to be supported. The main complexity is determination of quality level, as explained in the next section. Management of public keys of issuers must be reliable and continuously monitored for revocations and other updates. Certificate formats from different issuers have to be accounted for by specific parsers (although standardised profiles to some extent facilitates the task, but one needs to determine the profile in question). The validation service is not too complicated from a technical viewpoint, but management of the service requires resources. However, in many contexts, it is better to centralise this complexity rather than have to taclde it for each and every service separately.

This points at the question of how many, and which, certificate issuers one wants to support through the service. Several hundred public certificate issuer services exist world wide, with more to come. Additionally, one will increasingly find corporate (intranet) systems, which may be based on standard products from e.g. Microsoft or IBM/Lotus that allow anyone to establish a certificate issuing service. While most of these services will achieve very poor quality and trust ratings (e.g. issued without being backed by any policy) and be virtually useless outside of the company's intranet, situations may occur where one wants to be able to accept a certificate from a co-operating company, or a corporate customer.

The decision on this question is more of a management than a technical nature, as long as the validation service implementation's scaling properties are sufficient.

One crucial requirement is that the certificate must provide, directly or indirectly, the information that is needed for further processing, notably a name that can be used for access control and accounting.

With regard to categorisation of certificates and quality levels, a certificate issuing service is defined by the following components:
Legal framework and agreements;
Certificate policy, that provides requirements for procedures related to the service, and usually covers many of the aspects of the legal framework and agreements (that however frequently have to be made explicit, and thus warrants a separate point);
Certificate practice statement, that explains how the requirements of the policy are met by this particular certificate issuing service—may refer to internal procedure documents;
Certificate format, in particular naming conventions;
Trust model towards other actors, and especially attitude towards hierarchical structures and cross-certification regimes;
Information/directory services for certificates, revocation information, policy information and other relevant information.

Quality aspects of a certificate service are mainly derived from the certificate policy. The policy outlines requirements for the registration procedure that a user must go through in order to obtain a certificate (e.g. electronic application versus personal appearance with physical authentication etc.), liabilities that the issuer agrees to take on in case of errors, security requirements imposed on the operation of the service, and so on. Luckily, there are a few standard frameworks for writing policies, and most certificate issuers adhere to one of these. Certificate policies may therefore be compared point for point.

However, categorisation of certificate policies is a major manual task that requires some expertise. There is a need for categorisation criteria and a methodical foundation for the categorisation. Which criteria have to be fulfilled in order to reach a certain quality level? Add further complexities like policies written in foreign languages, and referring to laws and regulations from foreign countries. Unless someone comes up with an independent service for categorisation/classification of policies, one is forced to go through the evaluation process independently for all issuers. This means that one must start with a few crucial issuers, expanding this later as needed.

Continued monitoring of the policies supported must be done. However, policies will usually describe changing procedures, and many issuers will support active notification of other parties in case of substantial changes to policies.

A quality categorisation may be just a simple numerical value, say 1-4 with 1 as the top level and 4 as a poor quality level. There has been very little work on standardisation of such levels. Within the EU, the “qualified certificate” level has been (more or less) established as a high quality indicator to support formal digital signatures. In the USA, the “federal bridge certificate authority” defines some quality levels. A certificate issuer that provides services towards the federal. sector should cross-certify with the bridge indicating a policy mapping between its own policy and the appropriate quality level as defined by the bridge. ETSI currently works on a “non-qualified policy framework”, which will define some indicators that should be taken into account for categorisation of a policy.

Quality categorisation may also be a lot more fine-grained than just a level indicator. Based on the policy frameworks and ETSI's present work, some parameters may be derived from a policy into a structure that may be returned to the caller. As one example, the liability that a certificate issuer is willing to take may have an effect on the value of transactions that may be backed by an authentication based on a certificate from the issuer. The jurisdiction indicated by the policy is another important parameter.

Note that another issue is whether the quality level (the policy and related practices) is simply claimed by the certificate issuer, or if the claim is backed by third party evidence. Many certificate policies require third party auditing of the service, to ensure that actual operation is in accordance with the policy, practice statements, and internal procedures. Such an audit report will probably imply a higher quality rating, or at least more certainty about the rating. Certificates like ISO9000 or ISO17799 will also count here.

Finally, note that quality of service does not necessarily imply trust. The (imaginary) “Mafia CA” may achieve a high quality rating, but it is still not clear that its certificates should be accepted.

In addition to the certificate policy and the quality level, other aspects of the certificate issuing service must be taken in to account. In particular, one may impose requirements on certificate formats, like certain fields, attributes or extensions that must be present, or that should not be present. Naming is a separate issue, and for the system as defined today, it must be possible to translate from the name in the certificate to a valid username. Another requirement that may emerge in some cases is that the name must be “real”, and not a pseudonym.

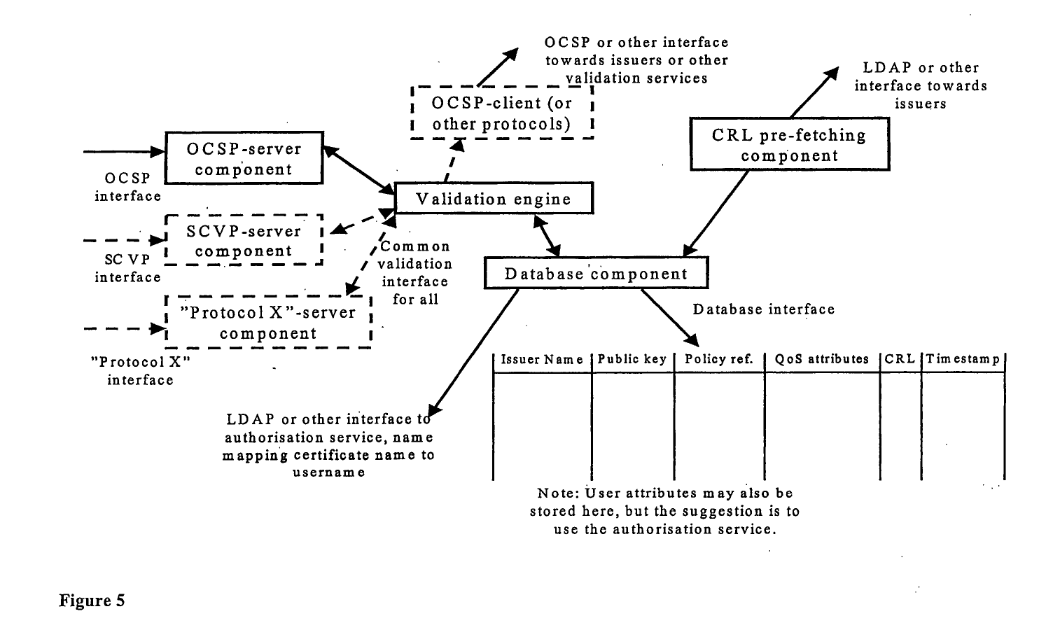

FIG. 5 shows a suggested architecture of the validation service. It consists of the following parts:
An OCSP-server that processes syntax and semantics related to this protocol. Further front-ends for other protocols may be added later, indicated as dotted lines.
A validation engine that processes the certificates, checks validity, and derives information.
A separate process for pre-fetching and processing of CRLs from all certificate authorities that are handled by the validation service.
An OCSP-client may be needed to access revocation information from certificate issuers that do not support CRLs.
A database that holds information about certificate issuers, their public keys, policies and related quality levels, revocation information as updated by the process mentioned above, and additional information that may be derived from certificates.
An interface (probably LDAP) towards the authorisation service in order to derive translations from the name in the certificate to a valid username for the system's domain, and possibly other name forms for other domains. This interface may be from the access server instead of the validation service, as discussed before.
The service will almost certainly need cryptographic hardware (not shown in FIG. 5).

With regard to operation, requests and replies, the OCSP-server, and other front-ends, performs the protocol dependent processing related to the validation service. This includes validation and generation of signatures on digitally signed requests and replies.

The front-ends have an API towards the validation engine. The validation engine must parse the certificate, if included, or otherwise act on the submitted certificate information.

Validation checks are then performed on the certificate: signature OK, certificate format OK, within validity period, not revoked or suspended. Some of these checks rely on a complete certificate, and cannot be done if only extracts of the certificate are submitted. Quality level is fetched based on the policy indicated in the certificate (or from pre-configured knowledge in the weird case that an issuer does not include the recommended policy identifier extension in its certificates). Derived information is then fetched from the database, and all is returned over the API to the OCSP-server (or other front-end) in the form specified by the API.

Revocation checking shall normally be just a local database lookup, since the CRL pre-fetching component shall gather the necessary information (described below). However, if a certificate issuer only provides an OCSP-interface for revocation checking, and no CRL-issuing service, then the validation engine must actually call the issuer's OCSP-service.

One may also imagine situations where validation services may be chained, and the call is done using a protocol (not necessarily OCSP) supported by a front-end of the remote validation service.

Most certificate authorities today, to our knowledge, use signed CRLs to inform of revocation and suspension of certificates. CRLs are usually issued regularly, with each CRL including the planned time of issue of the next version. However, CRLs may be issued before the schedule if necessary. Complete CRLs are usual, i.e. a CRL contains the serial numbers of all revoked certificates. A certificate is removed from future CRLs when the time of issue of the next CRL is after the normal expiration time of the certificate. Delta-CRLs, also called incremental CRLs, may be used, where a CRL contains only new entries since the previous CRL. With Delta-CRLs, complete CRLs are issued regularly, but much less frequent than the case when only complete CRLs are used.

Thus, the normal case for the CRL pre-fetching component is to run a deamon-process for each certificate issuer supported, and fetch and process the issuer's complete CRL at a time very closely after the scheduled time of issue. The result of the processing is stored in the database. However, there are some variants that will need to be supported, and the validation service needs to know the CRL strategies of the different certificate issuers, as documented in their policies. The validation service of course also needs to know the distribution points for CRLs, and it needs to have access to these points. CRLs should be openly available, but some issuers may want to charge for the fetching, in which case the cost must either be transferred to the callers, or accounted for in some other way.

If an issuer supports delta-CRLs, this should be utilised by the CRL pre-fetching component since the amount of data that needs to be downloaded for each fetch operation will be much smaller than for complete CRLs.

If an issuer has specified long intervals between CRLs, it is likely that this rather implies an “issue CRL when needed” strategy. In this case, the CRL pre-fetching component should poll for new CRLs regularly instead of waiting for the next scheduled issue. The interval that the validation service should be willing to accept between CRLs is a tuning parameter that influences the quality of the validation service. This interval should be equal to the polling time, and all issuers with a CRL frequency above the interval, should be polled.

For large-scale, international operation, one centralised installation that fetches potentially very large CRLs from all issuers will clearly be inefficient. An installation in Norway that every hour needs to fetch many MBs of information from hundreds of issuers around the world may work, but it will be inefficient, and propagation of revocation information will be slow. Therefore, a distributed architecture is more suitable for the CRL pre-fetching component, but describing this further is out of the scope of this document.

There may eventually be some issuers that do not use CRLs at all, but rely solely on an OCSP-interface for revocation checking. In this case, the CRL pre-fetching component can do nothing, and the validation engine must call the appropriate OCSP-interface (or another validation service, as noted above) whenever needed.

The strategies used by the CRL pre-fetching component must be tuned in more detail, as more parameters than those mentioned above will influence the results. The main requirement is the amount of delay that it is acceptable to introduce with respect to propagation of revocation information. It will necessarily be a “gap” between the issuing of a CRL and the time when this CRL has been processed by the CRL pre-fetching component. A request that arrives at the validation service during this gap, must either receive a delayed response—if the validation service waits for the CRL pre-fetching component to do its job—or risk an erroneous answer if the validation service answers immediately based on old revocation information.

There is also a risk that an issuer's CRL distribution service is overloaded by requests each time a scheduled CRL is issued, because many parties simultaneously try to download the new CRL to a local cache. To cope with this, some issuers implement an “over-issuing” strategy. CRLs are issued more frequently that the policy states. The CRL pre-fetching component must take such considerations into account.

The database will store information about each certificate issuer and its policies, and revocation information. It is possible to store user-related information as well, but in the described system context it is better to leave storage and management of user information to the authorisation service.

Issuer information will consist of the issuer name (as specified in the Issuer Name field in the certificates), identification of the policy in question (OID (Object Identifier) for the policy is (almost) always included in the certificates), the public key or the list of public keys (with validity intervals and key identifier/hash-value) that must be used to validate certificates, and quality attributes related to the policy and the issuer, as discussed earlier.

Management of issuer public keys is a headache today, as this is always in the form of local lists of trusted certificate issuers and their keys, often in the form of self-signed certificates (that provide integrity protection, but not authentication). In the system described, issuer key management is preferably centralised in the validation service. This is only possible if complete certificates are passed to the validation service, and local checking of the issuer's signature on certificates can be short-circuited on the calling system

Issuer keys are validated in a process that is partly manual (for quality assurance) and partly automatic, and are stored in the database. Revocation of an issuer key is a very rare event, but this is also a very severe event. Information channels must be monitored in order to ensure that such revocations are captured. In some cases, revocation will be through CRLs from issuers at a higher level of a hierarchy. In other cases, the certificate issuer in question will not be a member of any trust structure, and must arrange revocation on its own. However, revocation notification shall always be described in the policy.

Some issuers will have only one key pair in use at all times, except that key rollover for the issuer usually will imply an overlap where the old public key is still valid for certificate validation, while the private key is not valid for signing new certificates. Other issuers may adopt a policy for frequent key changes, in which case many keys may be valid (at least for certificate validation) at the same time. There is probably a need for manual procedures to keep the database of issuer public keys up to date.

Management of revocation information is done by the CRL pre-fetching component. Revocation checking is done locally by a database search to see if the serial number of the certificate in question is listed as revoked. Revocation information must be time-stamped: time of fetch operation for the current information, and scheduled time for next fetch.

The main motivation for the authorisation service is management and protection of user related information in a single place. It is customary today to have separate authentication and authorisation systems for each service, or at least for each service platform. Thus, management of subscription/user information—entering new information, changing, or deleting information—becomes cumbersome and vulnerable to mistakes.

The authorisation service keeps information related to each user in one database. The service and the database may be replicated. A “user” will usually be an individual but it may also be a subscriber identity, a group name, or some other named entity. The information is related to authentication and authorisations. Accounting information may easily be added to the system, although this is not described in this document. The information will be sensitive with respect to confidentiality and integrity, and the authorisation service and the database must be sufficiently secured.

Today, two standard protocols should be supported by the authorisation service: LDAP and RADIUS. The DIAMETER protocol should be supported when the specifications are ready. Other protocols may be supported. Since the authorisation service handles sensitive information, it must perform authentication and access control with respect to the entity that calls it before information is returned. This may be a part of the protocols used, be based on underlying protocols (like SSL, TLS, IPSec, or other VPN-technologies), or rely on dedicated communication channels (physical or logical) towards the counterparts. Due to use of different protocols, there will be a need for protocol specific front-ends, in the same way as described for the validation service.

The authorisation service performs name mapping for authentication and service access. The PKI-based authentication protocols used will authenticate the name in the certificate. This name can be shipped to the authorisation service, which will return the corresponding username. The name of the service for which a username is needed, should be a parameter of the call, since a user may have different usernames towards different services. A password may be returned along with the usernarne, if necessary and requested.

At later stages of a session, the authorisation service may be called to obtain more usernames when needed. The authorisation service may be handed a username/service pair, and be asked to translate this into another username/service pair for access to another service. The authorisation service must record the strength of the authentication mechanism last used for the named user, and act accordingly when granting or denying access to the service by returning the information or not.

The first level of authorisation in the system is for access to services as such. An authorisation may be linked to certain conditions, like use of an authentication mechanism of sufficient quality, allowed locations, use of certain equipment only, time of day and so on. Another condition is accounting and guaranteed payment, which is now up to the individual services but may be added in the authorisation service later on. All such conditions must be fulfilled in order for access to be granted.

Additionally, service specific authorisations may be stored in the database. In this case, the authorisation service may be called from the service itself upon access attempts to specific objects (like some piece of content), to decide whether or not the access request should be allowed.

Future extensions to the authorisation service are:
Issuing of cryptographically protected “tokens” as proofs of authorisations. This may be based on signed privilege (attribute) certificates, Kerberos tickets, or similar technologies.
Handling of delegation of authorisations from one user/actor to another.
Composition of authorisations from several users/actors for access decisions.
These issues are not described further in this document.

The system described bases authentication on available commercial (or non-commercial) certificate services. All certificate management, like registration, naming, issuing, and revocation, shall be taken care of by the certificate service providers.

The authorisation service needs to maintain a database of usernames and related privileges. Names in certificates will not be directly useable in this context. Thus, a mapping needs to be established between a username and the name(s) in the certificate(s) that the user wants to use to authenticate. This may be further extended by more usernames towards other services, possibly also passwords or other authentication information, to enable the access server to log a user transparently on to a service that only supports username/password as authentication mechanism. In addition to certificates, the system may be extended to cater for other authentication mechanisms, like username/password.

There may be cases where the naming format used by a particular certificate issuer can be automatically translated into a username. However, in most cases, the mapping from certificate name to username must be explicitly configured in the database. To avoid administrative overhead, this should for the main part be implemented as a self-service interface for the users. However, there will also be a need for an administrative interface and definition of operators with extended access rights to the database.

Users must have access to a self-service interface where they can submit a certificate and details about their subscription, in order to have the certificate name registered and linked to the username. The link between the two name forms must of course be established in a secure manner. A possibility is that new users are given two alternatives:

The first is to sign up for an account, and at the same time order an electronic ID from a preferred partner of the system owner, or from a list of alternative certificate issuers. Depending on the policy of the certificate issuer, the electronic ID may either be available for use immediately, or it may need to be activated at a later stage (e.g. if the user needs to obtain a smart card). However, for the authorisation service, the important information is the name that will appear in the certificate.

The second is to sign up for an account, and specify an existing certificate that will be used to authenticate the user. The applicability of the certificate must be checked against the (security) requirements, and one must verify that the certificate in deed belongs to the new user. It shall. be sufficient to register one certificate, and let the user add more certificates later.

Existing users must be allowed to register additional certificates or replacements for already registered certificates. This can be a self-administration procedure that may be available as a web-based service. Note that one needs to have rules for acceptable authentication methods related to the new method (new certificate) that will be registered. For instance, one cannot firstly introduce a low-quality certificate, and then use this to register a high-quality certificate as a new authentication method. The high-quality certificate will in this case effectively provide the same security as authentication based on the low-quality certificate but a given configuration may restrict access for a low-quality method while enabling access for a (seemingly in this case) high-quality authentication. Consequently, an authentication method can only be used to introduce new methods at the same security level or below.

To upgrade to a stronger authentication method, procedures along the lines followed for new users must be applied. Some self-administration is possible, but it may well be the case that manual procedures will have to be involved to a certain degree.

Administrators must be allowed to add, delete or alter information for other users. Administrators may be defined internally to the organisation that runs the authorisation service, relatively to (providers of) services that can be reached via the system, or relatively to for example corporate customers that need to manage subscriptions for several users. Administrators may use the same interface as ordinary users, or another one if better suited. Possibilities for batch processing of information, e.g. to add information about many users in one operation, is necessary.

In most cases, it is cost-effective to leave administration of subscriptions (i.e. authorisations to services) to the individual user. Thus, the self-service that is described for administration of authentication information must also cover other information about the user (actually, such use will probably be prevalent to management of authentication information).

The first level of authorisations is to services as such—subscribe to a service, or terminate a subscription. At a more fine-grained level, authorisations related to characteristics of individual services may be managed, if delegated from the service to the authorisation service. An example may be change of subscribed bandwidth for a communication service.

When users perform such administrative-procedures, authorisations and other restrictions must be obeyed. As one example, a user cannot subscribe to a service that requires a strong authentication procedure, unless a certificate of sufficient quality has been registered for the user. Another example is related to content subscription in a service, which may be restricted to persons above a certain age.

Administrators are also needed in order to manage authorisations. As one example, policy may dictate that only defined persons may manage access rights to certain services for corporate users. A batch-oriented interface is necessary to manage information about many users in one single operation.

1. System for providing secure service access for a user to at least one service from a service provider,
where the user and the service provider are provided with means for connection to a common computer network, said system comprising:
one or more validation service units arranged for performing the steps of:
receiving a name in a user certificate from an access server,
controlling the validity of the user certificate,
if the user's certificate is valid, either sending the user's certificate name to an authorization service unit for translation to a user name, and passing the user name returned from the authorization service unit to the access server, or passing the user's certificate name to the access server,
if the user's certificate is not valid, denying the user access to the service;
one or more authorization service units arranged for performing the steps of:
receiving a user's certificate name from a validation service unit or an access server,
sending the user's certificate name to a database,
receiving user name and profile from the database,
passing the named user identity to the validation service unit or the access server,
receiving a query for access rights from an access server,
querying for subscription info from the database,
receiving subscription info from the database,
determining access rights based on said subscription info,
passing access rights to the access server; and
one or more authorization role units and adjoining databases arranged for performing the steps of:
receiving a user's certificate from an authorization service unit,
locating the user's name and profile in the database,
sending user's name and profile to the authorization service unit,
receiving a query for subscription info from an authorization service unit,
sending subscription info to the authorization service unit.

2. System according to claim 1,
further comprising at least one access server, arranged for performing the steps of:
receiving a request from the user,
authenticating to user and asking for client authorization,
performing a challenge/response sequence,
requesting a certificate and proof of possession of a private key from the user,
passing the name in the certificate to a validation service unit,
in case of valid user certificate, receiving named user identity from an authorization service unit,
querying an authorization service unit for access rights,
receiving access rights from the authorization service unit,
locating an appropriate service menu,
presenting the service menu to the user, and
transferring information between the user and the service provider.

3. System according to claim 1 or 2,
wherein the access server comprises means for:
supporting HTTPS, or other means for securing communication channels,
authenticating the access server to clients/users, preferably by use of PKI technology,
supporting protocols necessary to communicate with the validation service and the authorization service unit,
supporting one or more protocols for PKI-based client/user authentication,
implementing the functionality needed to display information to the user and to handle user input,
acting as a proxy server between the user and a service.

4. System according to claim 1 or 2,
wherein requesting a certificate and a private key from the user may be performed by using a directory lookup.

5. System according to claim 1 or 2,
wherein the access server is adapted for mediating direct access to the service in a single sign-on manner.

6. System according to claim 1 or 2,
wherein the database storing the user name and profile, is also storing other user related information.

7. System according to claim 3,
wherein the access server, when using other means for securing the communication channel, is establishing a SLL/TLS session with the server authentication only, and running the user authentication protocol on the established secure channel.

8. System according to claim 3, wherein the user, in case of several alternatives of authentication methods, is presented with the choices, and the access server is establishing a SSL/TLS session with the chosen method of client authentication.

9. System according to claim 5,
wherein the service provider is included in the system and is adapted for accessing and exchanging information with the authorization service unit.

10. System according to claim 1,
wherein said validation service units, said authorization service units and said authorization role units are computer-implemented.

11. Use of the system according to claim 1 or 2 for providing authentication, authorization and access to a value-added service such as Video on Demand.

12. Use according to claim 10,
wherein the information is protected by encryption.

13. Method for providing secure service access for a user to at least one service from a service provider,
where the customer and the service provider are provided with means for connection to a common computer network,
said method comprising the steps of:
by means of one or more validation service units;
receiving a name in a user certificate from an access server,
controlling the validity of the user certificate,
if the user's certificate is valid, either sending the user's certificate name to an authorization service unit for translation to a user name, and passing the user name returned from the authorization service unit to the access server, or passing the user's certificate name to the access server, and
if the user's certificate is not valid, denying the user access to the service;
by means of one or more authorization service units:
receiving a user's certificate name from a validation service unit or an access server,
sending the user's certificate name to a database,
receiving user name and profile from the database,
passing the named user identity to the validation service unit or the access server,
receiving a query for access rights from an access server,
querying for subscription info from the database,
receiving subscription info from the database,
determining access rights based on said subscription info, and
passing access rights to the access server; and
by means of one or more authorization role units and adjoining databases:
receiving a user's certificate from an authorization service unit,
locating the user's name and profile in the database,
sending user's name and profile to the authorization service unit,
receiving a query for subscription info from an authorization service unit,
sending subscription info to the authorization service unit.

14. Method according to claim 13,
further comprising the following steps, performed by at least one access server:
receiving a request from the user,
authenticating to user and asking for client authorization,
performing a challenge/response sequence,
requesting a certificate and proof of possession of a private key from the user,
passing the name in the certificate to a validation service unit,
in case of valid user certificate, receiving named user identity from an authorization service unit,
querying an authorization service unit for access rights,
receiving access rights from the authorization service unit,
locating an appropriate service menu,
presenting the service menu to the user, and
transferring information between the user and the service provider.
